(19) United States
(12) Patent Application Publication
(10) Pub. No.: US 2026/0177856 A1
(43) Pub. Date: Jun. 25, 2026

(54) CROSSTALK REDUCTION USING MULTILAYER FILM ANGLE SHIFT

(71) Applicant: 3M INNOVATIVE PROPERTIES COMPANY, St. Paul, MN (US)

(72) Inventors: Lin Zhao, Woodbury, MN (US); Craig R. Schardt, Woodbury, MN (US); William J. Gray, Woodbury, MN (US); John A. Wheatley, Stillwater, MN (US); Gilles J. Benoit, Minneapolis, MN (US)

(21) Appl. No.: 19/125,858

(22) PCT Filed: Oct. 27, 2023
(86) PCT No.: PCT/IB2023/060862

§ 371 Date: Apr. 30, 2025

Related U.S. Application Data
(60) Provisional application No. 63/422,481, filed on Nov. 4, 2022.

(51) Int. Cl. G02F 1/1335; F21V 8/00; G02B 5/20; G02B 5/28

(52) U.S. Cl. CPC G02F 1/133528; G02B 5/201; G02B 5/287; G02B 6/0053

(57) ABSTRACT

An integral optical construction includes an optical film, a lens layer disposed on a first side of the optical film and having microlenses arranged two-dimensionally across the lens layer, and an optically opaque mask layer on a second side of the optical film defining a plurality of through openings. The openings have a one-to-one correspondence with the microlenses, such that, for a collimated incident light, for at least one polarization state, and for at least one of a blue wavelength range, a green wavelength range, and a red wavelength range, the optical film has an average transmittance T1 for an incident angle less than 10 degrees and an average transmittance T2 for an incident angle greater than 35 degrees, such that T1/T2≥1.5, and regions of the mask layer between openings have an average optical density of greater than about 2 in the blue, green, and red wavelength ranges.

### SUMMARY

In some aspects of the present description, an integral optical construction is provided, the integral optical construction including an optical film, a lens layer disposed on a major first side of the optical film, and an optically opaque mask layer disposed on a major second, opposite the first, side of the optical film. The optical film has a plurality of polymeric layers numbering at least 10 in total, where each of the polymeric layers has an average thickness of less than about 500 nm. The lens layer includes a plurality of microlenses arranged two-dimensionally across the lens layer. The optically opaque mask layer defines a plurality of substantially through openings therein. The openings are in a one-to-one correspondence with the microlenses of the lens layer, such that, for a substantially collimated incident light, for at least one polarization state, and for at least one of a blue wavelength range extending from about 420 nm to about 480 nm, a green wavelength range extending from about 490 nm to about 560 nm, and a red wavelength range extending from about 590 nm to about 670 nm, the optical film has an average optical transmittance T1 for a first incident angle of less than about 10 degrees and an average optical transmittance T2 for a second incident angle of greater than about 35 degrees, such that the ratio T1/T2 is greater than or equal to 1.5, and regions of the mask layer between the openings have an average optical density of greater than about 2 in each of the blue, green and red wavelength ranges.

In some aspects of the present description, an integral optical construction is provided, the integral optical construction including a lens layer, an optically opaque mask layer, and an optical film disposed between the lens layer and the mask layer. The lens layer includes a plurality of microlenses. The optically opaque mask layer defines a plurality of spaced-apart substantially through openings therein, such that the openings in a one-to-one correspondence with the microlenses. The optical film includes a plurality of polymeric layers numbering at least 10 in total. Each of the polymeric layers has an average thickness of less than about 500 nm. For a substantially collimated light incident on the optical construction, for at least one polarization state, and for at least one wavelength in a visible wavelength range extending from about 420 nm to about 680 nm, and for an integral comparative optical construction that has a same construction as the integral optical construction except that it does not include the optical film, the optical construction and the comparative optical constructions have respective optical transmittances M1 and Mc1 for a first incident angle of less than about 10 degrees and respective optical transmittances M2 and Mc2 for a second incident angle of greater than about 25 degrees, such that the ratio M1/Mc1 is greater than or equal to 0.5, and the ratio Mc2 is greater than or equal to 2%, and the ratio M2/Mc2 is less than or equal to about 0.7.

### BRIEF DESCRIPTION OF THE DRAWINGS

FIGS. 1A and 1B provide views of a display system including an integral optical construction, in accordance with an embodiment of the present description;

FIG. 2 is a side view of a multilayer optical film construction, in accordance with an embodiment of the present description;

FIGS. 3A and 3B provide information on the optical characteristics of an integral optical construction, in accordance with an embodiment of the present description;

FIG. 4 is a side view of a comparative integral optical construction, without the multilayer optical film of the present description;

FIGS. 5A and 5B provide additional information on the optical characteristics of an integral optical construction as compared to the comparative integral optical construction of FIG. 4, in accordance with an embodiment of the present description;

FIGS. 6A and 6B provide additional information on the optical characteristics of an integral optical construction, in accordance with an embodiment of the present description; and

FIGS. 7A and 7B provide views of an integral optical construction, in accordance with an embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Many mobile devices today rely on fingerprint sensing to provide security and identification features to the device. Often, sensors for detecting the light reflected from an object near the screen (such as the surface of a finger) are placed behind the display. Optical film stacks for displays may be designed to allow light reflected from a finger to pass through the display to the sensor beneath. Optical films in the display may be designed to help direct the reflected light to the optical sensor and limit light contamination from other sources. For example, a lenslet aperture film might be used as an angular filter in an attempt to reduce light interference from the environment surrounding the mobile device. However, optical crosstalk (where stray light from one lenslet transmits through a neighboring aperture) can limit performance improvements to the optical system.

According to some aspects of the present description, an integral optical construction uses a wavelength-selective multilayer optical film (MOF) in combination with a lenslet aperture film to reduce optical crosstalk while maintaining good on-axis optical transmission. In some embodiments, the integral optical construction includes an optical film, a lens layer disposed on a major first side of the optical film, and an optically opaque mask layer disposed on a major second, opposite the first, side of the optical film.

In some embodiments, the optical film includes a plurality of polymeric layers numbering at least 10, or at least 20, or at least 50, or at least 100, or at least 150, or at least 200, or at least 250, or at least 300 in total. In some embodiments, each of the polymeric layers may have an average thickness of less than about 500 nm, or less than about 450 nm, or less than about 400 nm, or less than about 350 nm, or less than about 300 nm, or less than about 250 nm, or less than about 200 nm. In some embodiments, the lens layer may include a plurality of microlenses arranged two-dimensionally (e.g., across orthogonal x- and y-axes of the lens layer) across the lens layer. In some such embodiments, the microlenses in the plurality of microlenses may include a plurality of meta-lenses having a plurality of nanostructures. In some such embodiments, the meta-lenses may be embedded in a material. As used in this description, a meta-lens includes a meta-surface that includes a plurality (e.g., an array) of nanostructures. In such embodiments, the nanostructures may be configured to redirect or bend an incident light by modifying the phase of the incident light.

In some embodiments, the optically opaque mask layer may define a plurality of substantially through openings therein. In some embodiments, each of the openings may extend from a first major surface of the mask layer facing the optical film to an opposite second major surface of the mask layer. In some embodiments, at least 60%, or at least 70%, or at least 80%, or at least 85%, or at least 90%, or at least 95% of a total volume of each of the openings may be filled with air. In other embodiments, at least 60%, or at least 70%, or at least 80%, or at least 85%, or at least 90%, or at least 95% of a total volume of each of the openings may be filled with a material other than air (e.g., an optically clear adhesive).

In some embodiments, the integral optical construction may further include an optical adhesive layer disposed on, and making physical contact with, the second major surface of the mask layer. In some such embodiments, wherein each of the openings extends from the first major surface of the mask layer to the second major surface, the optical adhesive layer may fill more than about 50%, or about 60%, or about 70%, or about 80%, or about 90%, or about 95%) of a total volume of each of the openings.

In some embodiments, the openings may be disposed in a one-to-one correspondence with the microlenses, such that for a substantially collimated incident light, for at least one polarization state (e.g., mutually orthogonal first, x-axis, and second, y-axis, polarization states), and for at least one of a blue wavelength range extending from about 420 nm to about 480 nm, a green wavelength range extending from about 490 nm to about 560 nm, and a red wavelength range extending from about 590 nm to about 670 nm, the optical film may have an average optical transmittance T1 for a first incident angle of less than about 10 degrees, or less than about 8 degrees, or less than about 6 degrees, or less than about 4 degrees, or less than about 2 degrees, or less than about 1 degree, and an average optical transmittance T2 for a second incident angle of greater than about 35 degrees, or greater than about 40 degrees, or greater than about 45 degrees, or greater than about 50 degrees, or greater than about 55 degrees, or greater than about 60 degrees, such that the ratio of T1/T2 is greater than or equal to 1.5, or greater than or equal 2, or greater than or equal 2.5, or greater than or equal 5, or greater than or equal 10, or greater than or equal 25, or greater than or equal 50, or greater than or equal 100, or greater than or equal 150, or greater than or equal 200. In some embodiments, regions of the mask layer between the openings may have an average optical density of greater than about 2, or greater than about 2.5, or greater than about 3, or greater than about 3.5, or greater than about 4, or greater than about 4.5, or greater than about 5, or greater than about 5.5, or greater than about 6 in each of the blue, green and red wavelength ranges.

In some embodiments, for the at least one polarization state and for at least one wavelength between at least one of the blue and green wavelength ranges and the green and red wavelength ranges, the optical film may have an optical transmittance T3 of less than about 15%, or less than about 10%, or less than about 8%, or less than about 6%, or less than about 5%, or less than about 4%, or less than about 3%, or less than about 2%.

In some embodiments, a display system may include a light source (e.g., a light-emitting diode) and any of the integral optical constructions described herein. In some embodiments, the integral optical construction may be disposed between an optical sensor and a display panel (e.g., a liquid crystal display panel) configured to generate an image for viewing by a user. In some such embodiments, the light source may be configured to emit a light toward at least a finger (or a stylus) of the user disposed proximate the display panel. In some embodiments, the optical sensor may be configured to at least sense a presence of the finger by receiving at least a portion of the emitted light reflected by the finger. In some embodiments, the light source may be disposed inside the display panel. In some embodiments, the light source may be one or more pixels of the display panel. In other embodiments, the light source may be disposed on a lateral side of the display system. In some embodiments, the emitted light from the light source may have a wavelength between about 800 nm and about 2000 nm, or between about 800 nm and about 1500 nm, or between about 800 nm and about 1200 nm. In some embodiments, the emitted light may have a visible wavelength between about 400 nm and about 800 nm.

According to some aspects of the present description, an integral optical construction includes a lens layer, an optically opaque mask layer, and an optical film disposed between the lens layer and the mask layer. In some embodiments, the lens layer may include a plurality of microlenses. In some embodiments, the optically opaque mask layer may define a plurality of spaced-apart substantially through openings therein, the openings in a one-to-one correspondence with the microlenses. In some embodiments, each of the openings may extend from a first major surface of the mask layer facing the optical film to an opposite second major surface of the mask layer. In some embodiments, at least 60%, or at least 70%, or at least 80%, or at least 85%, or at least 90%, or at least 95% of a total volume of each of the openings may be filled with air. In other embodiments, at least 60%, or at least 70%, or at least 80%, or at least 85%, or at least 90%, or at least 95% of the total volume of each of the openings may be filled with a material other than air (e.g., an optically clear adhesive).

In some embodiments, the optical film may include a plurality of polymeric layers numbering at least 10, or at least 20, or at least 50, or at least 100, or at least 150, or at least 200, or at least 250, or at least 300 in total. In some embodiments, each of the polymeric layers may have an average thickness of less than about 500 nm, or less than about 450 nm, or less than about 400 nm, or less than about 350 nm, or less than about 300 nm, or less than about 250 nm, or less than about 200 nm.

In some embodiments, for a substantially collimated light incident on the optical construction, for at least one polarization state (e.g., an x-axis or a y-axis of the optical construction), and for at least one wavelength in a visible wavelength range extending from about 420 nm to about 680 nm, and for an integral comparative optical construction that has a same construction as the integral optical construction except that it does not include the optical film (i.e., the space occupied by the optical film in embodiments of the present description is replaced with a layer having a similar thickness as the optical film and a uniform refractive index chosen such that the pinhole array (i.e., the openings in the opaque mask layer) is located at the focus of the lens array), the optical construction and the comparative optical constructions may have respective optical transmittances M1 and Mc1 for a first incident angle of less than about 10 degrees, or less than about 8 degrees, or less than about 6 degrees, or less than about 4 degrees, or less than about 2 degrees, or less than about 1 degree, and respective optical transmittances M2 and Mc2 for a 15 second incident angle of greater than about 25 degrees, or greater than about 30 degrees, or greater than about 35 degrees, or greater than about 40 degrees, or greater than about 45 degrees, or greater than about 50 degrees, or greater than about 55 degrees, or greater than about 60 degrees, the ratio of M1/Mc1 may be greater than or equal to 0.5, Mc2 may be greater than about 2%, or greater than about 3%, or greater than about 4%, or greater than about 5%, or greater than about 6%, or greater than about 7%, or greater than about 8%, or greater than about 9%, or greater than about 10%, and the ratio of M2/Mc2 may be less than 20 or equal to 0.7, or less than or equal to 0.6, or less than or equal to 0.5, or less than or equal to 0.4, or less than or equal to 0.3, or less than or equal to 0.2, or less than or equal to 0.1, or less than or equal to 0.05.

In some embodiments, when the mask layer further includes a first major surface facing the optical film and an opposite, second major surface, the integral optical construction may further include an optical adhesive layer disposed on, and making physical contact with, the second major surface of the mask layer. In some such embodiments, the optical adhesive layer may fill more than about 50%, or more than about 60%, or more than about 70%, or more than about 80%, or more than about 90%, or more than about 95% of the total volume of each of the openings.

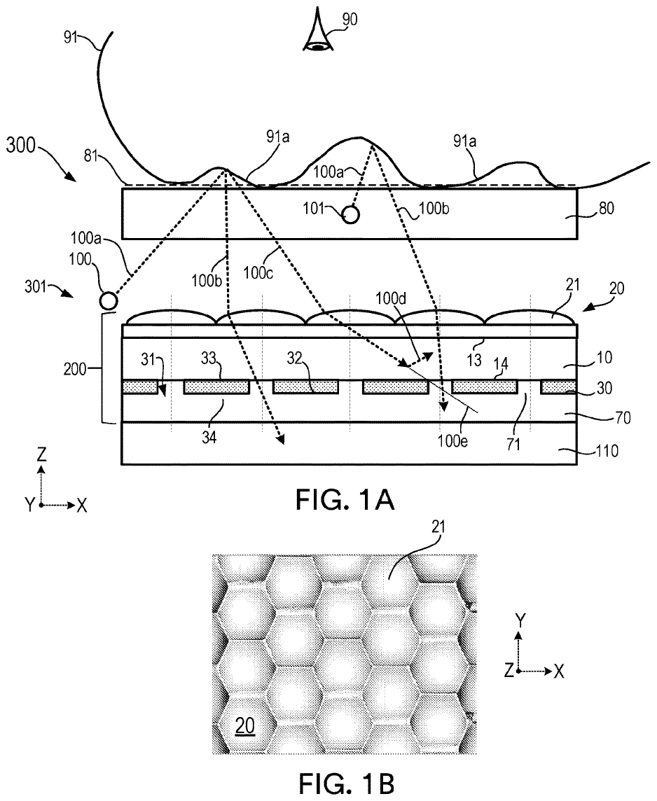

Turning now to the figures, FIGS. 1A and 1B provide views of a display system including an embodiment of an integral optical construction according to the present description. In some embodiments, display system 300 includes a display panel 80, one or more light sources 100, 101, an integral optical construction 200, and an optical sensor 110. In some embodiments, display panel 80 is configured to generate an image 81 for viewing by a user 90. In some embodiments, the light source 100, 101 may emit a light 100a toward an object 91 (e.g., a finger of the user 90), such that the light 100a is reflected from object 91, and at least a portion of light 100a is reflected as reflected light 100b. In some embodiments, reflected light 100b passes through optical construction 200 and is received by optical sensor 110, enabling optical sensor 110 to at least sense the presence of object 91.

In some embodiments, light source 100 may be disposed on a lateral side 301 of display system 300. In some embodiments, light source 101 may be disposed inside display panel 80. In some embodiments, emitted light 100a may include a visible wavelength between about 400 nm and about 800 nm. In some embodiments, emitted light 100a may include a wavelength between about 800 nm and about 2000 nm, or between about 800 nm and about 1500 nm, or between about 800 nm and about 1200 nm.

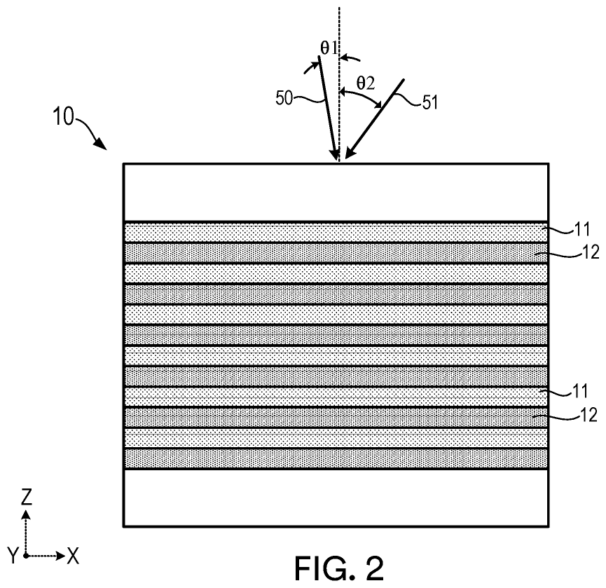

In some embodiments, integral optical construction 200 may include an optical film 10, a lens layer 20, and an optically opaque mask layer 30. In some embodiments, the optical film may include a plurality of polymeric layers (e.g., see FIG. 2). In some embodiments, lens layer 20 may be disposed on a major first side 13 of optical film 10 and may include a plurality of microlenses 21 arranged two-dimensionally (e.g., arranged across a plane defined by the x- and y-axes as defined in FIG. 1A) across the lens layer 20. Refer also to FIG. 1B, showing a top, plan view of lens layer 20 featuring a plurality of microlenses 21.

In some embodiments, the optically opaque mask layer 30 may be disposed on a major second side 14 of optical film 10, the major second side 14 opposite major first side 13 of optical film 10. In some embodiments, optically opaque mask layer (or more simply “mask layer”) 30 may define a plurality of substantially through openings 31 therein. In some embodiments, the through openings 31 extend from a first major surface 33 of mask layer 30 to an opposite, second major surface 34 of mask layer 30. In some embodiments, openings 31 may be in a one-to-one correspondence with microlenses 21 (i.e., substantially aligned with microlenses 21, as shown by the dashed vertical lines in FIG. 1A.

FIG. 1A shows object 91 as a line representing the contours 91a of the object 91. For example, object 91 may be a finger of user 90, and contours 91a may be the ridges of a fingerprint. Light 100a emitted by light sources 100, 101 may be reflected as reflected light 100b and/or 100c. A portion of the reflected light (100b) may be reflected at such an angle such that the light is transmitted by optical film 10 and through openings 31 in opaque mask layer 30, while another portion of the reflected light (100c) may be reflected at such an angle that the light is substantially blocked or reflected by optical film 10 (see, for example, reflected light 100d reflected from an interior of optical film 10) and not allowed to follow path 100e through opaque mask layer 30 which would have led to crosstalk contamination.

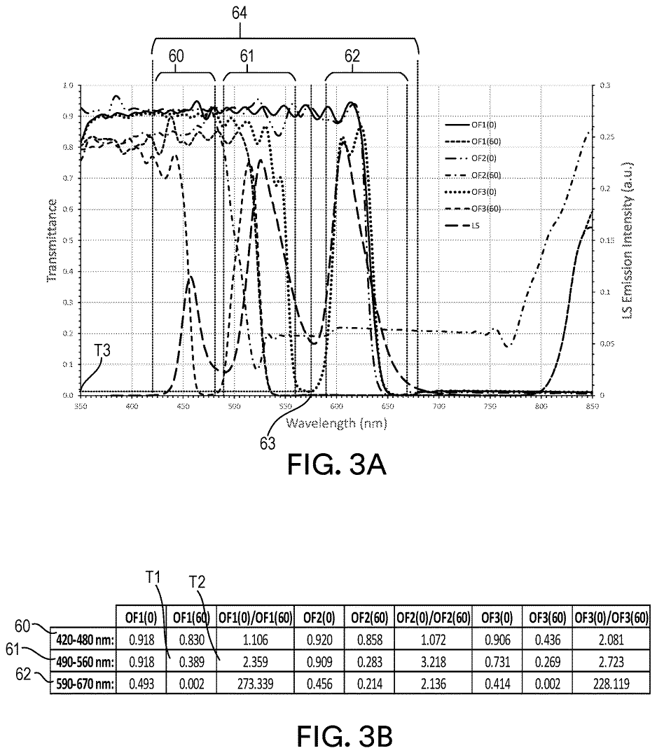

In some embodiments, integral optical construction 300 may further include an optical adhesive layer 70 disposed on, and making physical contact with, second major surface 34 of mask layer 30. In some such embodiments, when each of the openings 31 extends from first major surface 33 of mask layer 30 to second major surface 34 of the mask layer 30, the optical adhesive layer 70 may fill more than about 50%, or more than about 60%, or more than about 70%, or more than about 80%, or more than about 90%, or more than about 95% of a total volume of each of openings 31. In some embodiments, mask layer 30 further includes regions 32 between openings 31. In some embodiments, regions 32 may have an average optical density of greater than about 2, or greater than about 2.5, or greater than about 3, or greater than about 3.5, or greater than about 4, or greater than about 4.5, or greater than about 5, or greater than about 5.5, or greater than about 6 in each of blue, green, and red wavelength ranges (e.g., see blue 60, green 61, and red 62 wavelength ranges as defined in FIG. 3A). In some embodiments, at least 60%, or at least 70%, or at least 80%, or at least 85%, or at least 90%, or at least 95% of a total volume of each of the openings 31 is filled with air. In some embodiments, at least 60%, or at least 70%, or at least 80%, or at least 85%, or at least 90%, or at least 95% of a total volume of each of the openings 31 is filled with a material 71 other than air.

FIG. 2 is a side view showing the layered architecture of an optical film, such as the embodiment of optical film 10 of FIG. 1A. In some embodiments, the optical film 10 may include a plurality of polymeric layers (e.g., microlayers) 11, 12 numbering at least 10, or 20, or 30, or 40, or 50, or 100, or 150, or 200, or 250, or 300 in total. In some embodiments, each of the polymeric layers 11, 12 may have an average thickness of less than about 500 nm, or 450 nm, or 400 nm, or 350 nm, or 300 nm, or 250 nm, or 200 nm. In some embodiments, the indices of refraction of polymeric layers 11, 12, and/or the total number of polymeric layers 11,12, and/or the thickness profile exhibited by the plurality of polymeric layers 11, 12 as a whole may be configured so that a desired optical transmission/reflection profile may be created for optical film 11. In some embodiments, optical film 10 may have additional layers (e.g., outer “skin” layers such as those shown, but not numbered, above and below the plurality of polymeric layers 11, 12 in FIG. 2).

In some embodiments, a substantially collimated incident light 50, 51 may exhibit a different average optical transmittance for each of a first incident angle θ1 and a second incident angle θ2. That is, the amount of optical transmittance may vary as a function of the angle of incidence. In some embodiments, the presence of lens layer 20 changes the angle of incidence of light that reaches opaque mask layer 30, enabling improved angle filtering of light through the stack.

Additional details on the optical characteristics of at least one embodiment optical film 10 are provided elsewhere herein. For example, FIGS. 3A and 3B provide information on the optical characteristics of integral optical construction such as the embodiment of integral optical construction 200 in FIG. 1A.

In some embodiments, for a substantially collimated incident light 50, 51 (as shown in FIG. 2), and for at least one polarization state (e.g., polarized to either x-axis or y-axis as defined in FIG. 1A), and for at least one of a blue wavelength range 60 extending from about 420 nm to about 480 nm, a green wavelength range 61 extending from about 490 nm to about 560 nm, and a red wavelength range 62 extending from about 590 nm to about 670 nm, optical film 10 (e.g., optical film 10 of FIG. 1A or FIG. 2) may have an average optical transmittance T1 for a first incident angle (e.g., θ1 of FIG. 2) of less than about 10 degrees, or less than about 8 degrees, or less than about 6 degrees, or less than about 4 degrees, or less than about 2 degrees, or less than about 1 degree and an average optical transmittance T2 for a second incident angle (e.g., θ2 of FIG. 2) of greater than about 35 degrees, or greater than about 40, or greater than about 45, or greater than about 50, or greater than about 55, or greater than about 60 degrees. In such embodiments, the ratio of T1/T2 may be greater than or equal to about 1.5, or greater than or equal to about 2, or greater than or equal to about 2.5, or greater than or equal to about 5, or greater than or equal to about 10, or greater than or equal to about 25, or greater than or equal to about 50, or 100, or greater than or equal to about 150, or greater than or equal to about 200.

For example, FIG. 3A shows plotlines for three different optical film examples, OF1, OF2, and OF3. Each film OF1, OF2, OF3 corresponds to two different plotlines in FIG. 3A. OF1(0) shows the optical transmission curve for film OF1 given an incident light 50 at an angle of incidence θ1 of 0 degrees (e.g., substantially normal to the optical film surface), and OF1(60) shows the optical transmission curve for the same film (OF1) given an incident light 51 at an angle of incidence θ2 of 60 degrees. Similar plotlines are provided for OF2(0), OF2(60), OF3(0), and OF3(60).

FIG. 3B provides a table summarizing the average optical transmission values representative of the data in the graph of FIG. 3A. Each row in FIG. 3B represents one of the blue wavelength range 60, green wavelength range 61, and red wavelength range 62. Each column in FIG. 3B shows the optical average transmission seen for each film and each angle of incidence for the three wavelength ranges. For example, looking at the green wavelength range 61 in the table, we see that OF1 has a transmission value of 0.92 (92%) with an angle of incidence of 0 degrees (labeled as T1), and OF1 has an optical transmission value of 0.39 (39%) with an angle of incidence of 60 degrees (labeled as T2). The ratio of T1/T2 for each of the films OF1, OF2, OF3 in the green wavelength range 61 is 2.36, 3.22, and 2.72, respectively, as shown in the table of FIG. 3B.

Returning to FIG. 3A, for the at least one polarization state and for at least one wavelength 63 (e.g., 555 nm as shown in FIG. 3A) between at least one of the blue and green wavelength ranges and the green and red wavelength ranges, the optical film may have an optical transmittance T3 of less than about 15%, or less than about 10%, or less than about 8%, or less than about 6%, or less than about 5%, or less than about 4%, or less than about 3%, or less than about 2% (T3 is shown as about 0.02 or 2% in FIG. 3A).

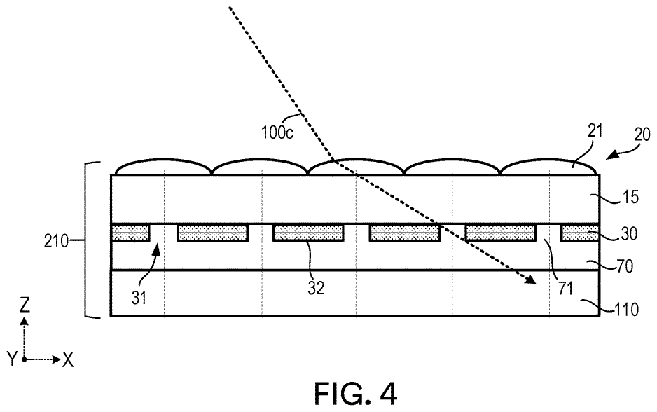

FIG. 4 is a side view of a comparative integral optical construction 210 without the multilayer optical film of the present description. The comparative integral optical construction 210 of FIG. 4 is of a same construction as integral optical construction 200 of FIG. 1A but comparative integral optical construction 210 does not include optical film 10. (Instead, optical film 10 is replaced with a layer 15 with similar thickness and a uniform refractive index chosen such that the “pinhole array” of the opaque mask layer 30 is located at the focus of the lenslet array of lens layer 20.)

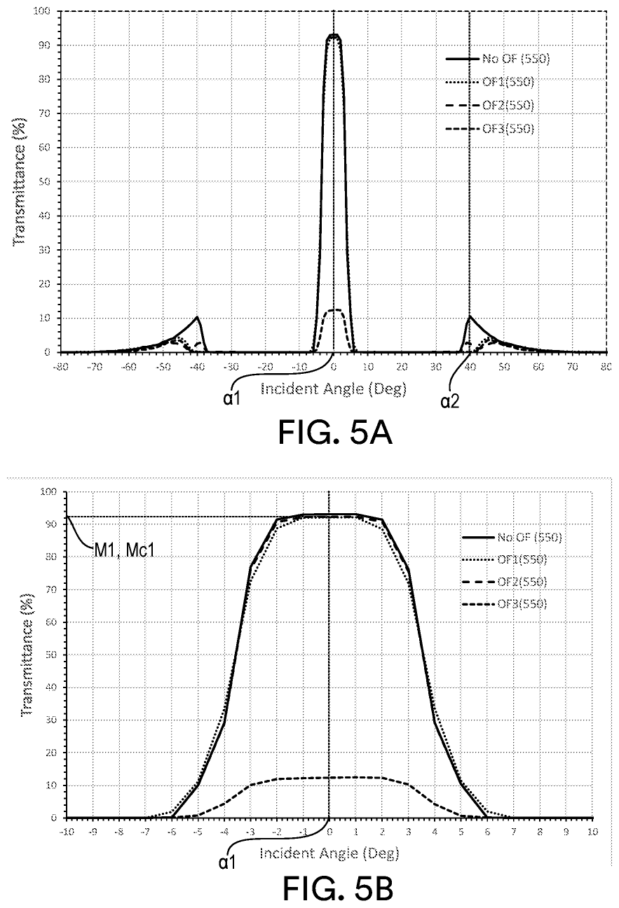

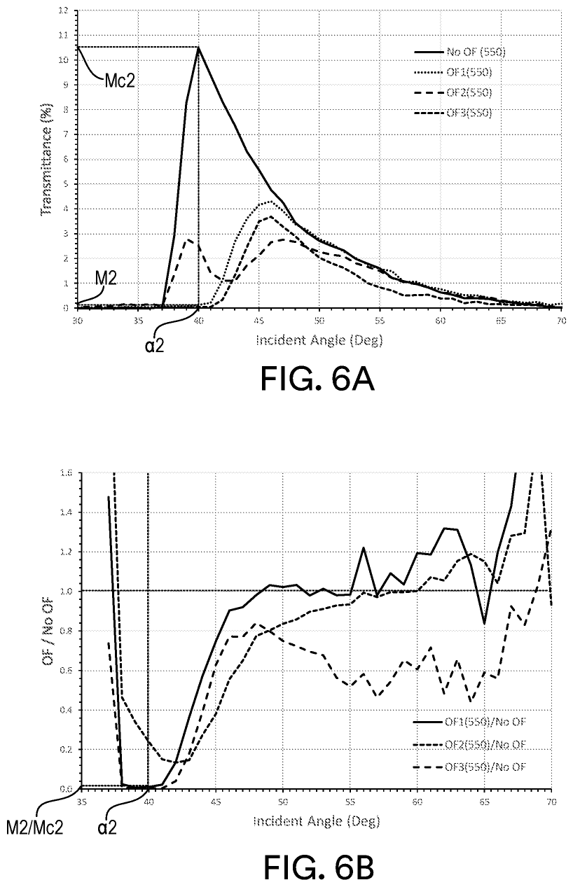

Other than the absence of optical film 10 (and its replacement with layer 15), comparative integral optical construction 210 includes the other components of integral optical construction 200, and like-numbered components between construction 200 and 210 are assumed to have the same function and will therefore not be described again here. FIG. 4 is provided for discussion purposes and the optical performance of integral optical construction 200 will be compared to the optical performance of comparative integral optical construction 210 in FIGS. 5A and 5B and FIGS. 6A and 6B.

In the comparative integral optical construction 210 of FIG. 4, reflected light 100c from FIG. 1A is shown (at an angle similar to that shown in FIG. 1A). Because of the absence of optical film 10 in this embodiment, reflected light 100c is transmitted through replacement layer 15 and passes through one or more openings 31 in opaque mask layer 30, creating “crosstalk” contamination at optical sensor 110 (instead of being reflected or blocked by optical film 10, as was shown in FIG. 1A).

Turning first to FIGS. 5A and 5B, the optical construction 200 and the comparative optical construction 210 may have respective optical transmittances M1 and Mc1 for a first incident angle α1 of less than about 10 degrees, or less than about 8 degrees, or less than about 6 degrees, or less than about 4 degrees, or less than about 2 degrees, or less than about 1 degree (e.g., an α1 of 0 degrees). For example, values for M1 and Mc1 are shown in FIG. 5A, which is a close-up view of the graph shown in FIG. 5A, showing the optical transmittance values M1 and Mc1 at α1 (0 degrees). Similarly, FIG. 6A is a close-up view of the graph of FIG. 5A but showing the optical transmission values M2 and Mc2 at α2 (40 degrees).

As shown in FIGS. 5B and 6A, the ratio of M1/Mc1 may be greater than or equal to about 0.5, and the ratio of M2/Mc2 may be less than or equal to about 0.7, or less than or equal to about 0.6, or less than or equal to about 0.5, or less than or equal to about 0.4, or less than or equal to about 0.3, or less than or equal to about 0.2, or less than or equal to about 0.1, or less than or equal to about 0.05. For example, Mc2 (transmission of the comparative optical construction 210 without optical film 10) at an α2 value of 40 degrees is about 10.5%, and M2 (transmission of the optical construction 200 with optical film 20) is about 0.01%. Stated another way, the presence of optical film 10 in integral optical construction 200 significantly reduces the amount of optical transmission at higher angles of incidence (e.g., 40 degrees). FIG. 6B shows plots of M2/Mc2 (ratio of transmission for optical films OF1, OF2, and OF3 with optical film 10 to transmission for similar films without optical film 10) at an angle of incidence of 40 degrees.

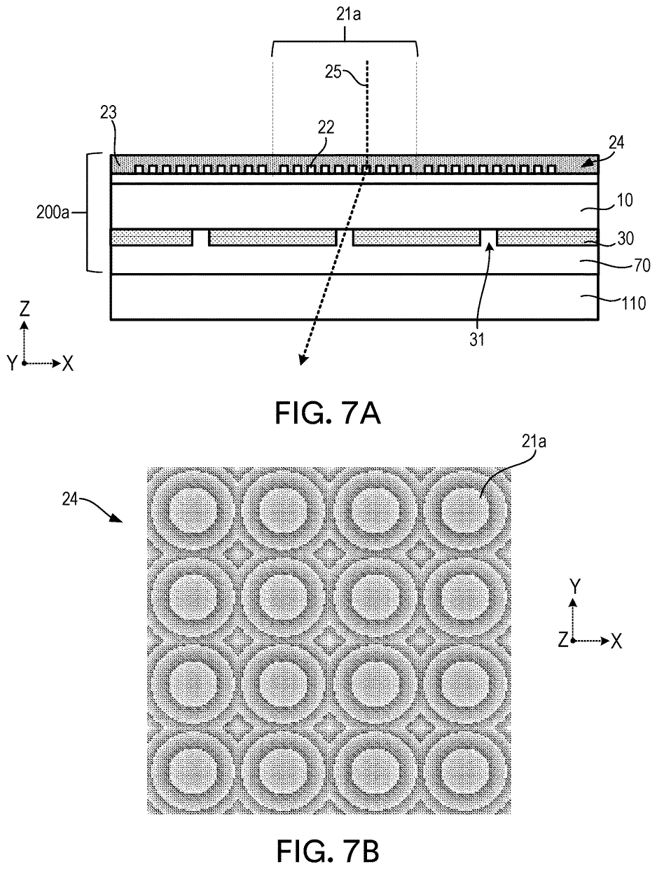

FIGS. 7A and 7B provide views of an alternate embodiment 200a of an integral optical construction 200a. The alternate embodiment shown in FIGS. 7A and 7B is similar to the embodiment of integral optical construction 200 of FIG. 1A, and all like-numbered components should be assumed to have the same function. In alternate embodiment 200a, the microlenses include a plurality of meta-lenses 21a which include a plurality of nanostructures 22. For the purposes of this description, a meta-lens 21a includes a meta-surface 24 that includes a plurality, such as a regular array, of nanostructures 22. In some embodiments, the nanostructures 22 may be configured to redirect or bend an incident light 25 by modifying the phase of the incident light 25.

In some embodiments, the nanostructures 22 may be made of a high refractive index material which may include a semiconductor, metal oxide, or metal nitride. The high refractive index material may include at least one of silicon, germanium, titanium, zirconium, tantalum, hafnium, niobium, zinc, or cerium; an oxide of titanium, zirconium, tantalum, hafnium, niobium, zinc, or cerium; a nitride of titanium, zirconium, tantalum, hafnium, niobium, zinc, or cerium; a sulfide of titanium, zirconium, tantalum, hafnium, niobium, zinc, or cerium; or a combination thereof.

In some embodiments, the nanostructures 22 may be embedded in a matrix material 23 with a lower refractive index than the nanostructures. The matrix material 23 may be formed of thermoplastic material. The matrix material 23 may be formed of poly(methyl methacrylate), polycarbonate, polypropylene, polyethylene, polystyrene, polyester, or polyamide. The matrix material 23 may be formed of polymerizable compositions comprising acrylate or methacrylate components. The matrix material 23 may include a fluoropolymer, (meth)acrylate (co) polymer, or silica containing polymers.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An integral optical construction comprising:
an optical film comprising a plurality of polymeric layers numbering at least 10 in total, each of the polymeric layers having an average thickness of less than about 500 nm;
a lens layer disposed on a major first side of the optical film and comprising a plurality of microlenses arranged two-dimensionally across the lens layer; and
an optically opaque mask layer disposed on a major second, opposite the first, side of the optical film and defining a plurality of substantially through openings therein, the openings in a one-to-one correspondence with the microlenses, such that for a substantially collimated incident light, for at least one polarization state, and for at least one of a blue wavelength range extending from about 420 nm to about 480 nm, a green wavelength range extending from about 490 nm to about 560 nm, and a red wavelength range extending from about 590 nm to about 670 nm:
the optical film has an average optical transmittance T1 for a first incident angle of less than about 10 degrees and an average optical transmittance T2 for a second incident angle of greater than about 35 degrees, T1/T2≥1.5; and
regions of the mask layer between the openings have an average optical density of greater than about 2 in each of the blue, green, and red wavelength ranges.

2. The integral optical construction of claim 1, wherein each of the openings extends from a first major surface of the mask layer facing the optical film to an opposite second major surface of the mask layer.

3. The integral optical construction of claim 2, wherein at least 60% of a total volume of each of the openings is filled with air.

4. The integral optical construction of claim 2, wherein at least 60% of a total volume of each of the openings is filled with a material other than air.

5. The integral optical construction of claim 1, wherein the mask layer further comprises a first major surface facing the optical film and an opposite second major surface, and the integral optical construction further comprises an optical adhesive layer disposed on, and making physical contact with, the second major surface of the mask layer.

6. The integral optical construction of claim 5, wherein each of the openings extends from the first major surface of the mask layer facing the optical film to the second major surface (34) of the mask layer, and wherein the optical adhesive layer fills more than about 50% of a total volume of each of the openings.

7. The integral optical construction of claim 5, wherein for the at least one polarization state and for at least one wavelength between at least one of the blue and green wavelength ranges and the green and red wavelength ranges, and the optical film has an optical transmittance of less than about 15%.

8. A display system comprising a light source, and the integral optical construction of claim 1 disposed between an optical sensor and a display panel configured to generate an image for viewing by a user, the light source configured to emit a light toward at least a finger of the user disposed proximate the display panel, the optical sensor configured to at least sense a presence of the finger by receiving at least a portion of the emitted light reflected by the finger.

9.-10. (canceled)

11. The display system of claim 8, wherein the emitted light has a wavelength between about 800 nm and about 2000 nm.

12. The display system of claim 8, wherein the emitted light has a visible wavelength between about 400 nm and about 800 nm.

13. The integral optical construction of claim 1, wherein the at least one polarization state comprises each of mutually orthogonal first and second polarization states.

14. The integral optical construction of claim 1, wherein the microlenses in the plurality of microlenses comprise a plurality of meta-lenses comprising a plurality of nanostructures.

15. The integral optical construction of claim 1, wherein the meta-lenses are embedded in a material.

16. An integral optical construction comprising:
a lens layer comprising a plurality of microlenses;
an optically opaque mask layer defining a plurality of spaced-apart substantially through openings therein, the openings in a one-to-one correspondence with the microlenses; and
an optical film disposed between the lens layer and the mask layer and comprising a plurality of polymeric layers numbering at least 10 in total, each of the polymeric layers having an average thickness of less than about 500 nm,
such that for a substantially collimated light incident on the optical construction, for at least one polarization state, and for at least one wavelength in a visible wavelength range extending from about 420 nm to about 680 nm, and for an integral comparative optical construction that has a same construction as the integral optical construction except that it does not include the optical film:
the optical construction and the comparative optical constructions have respective optical transmittances M1 and Mc1 for a first incident angle of less than about 10 degrees and respective optical transmittances M2 and Mc2 for a second incident angle of greater than about 25 degrees, M1/Mc1≥0.5, Mc2≥2%, and M2/Mc2≤0.7.

17. The integral optical construction of claim 16, wherein each of the openings extends from a first major surface of the mask layer facing the optical film to an opposite second major surface of the mask layer.

18. The integral optical construction of claim 17, wherein at least 60% of a total volume of each of the openings is filled with air.

19. The integral optical construction of claim 17, wherein at least 60% of a total volume of each of the openings is filled with a material other than air.

20. The integral optical construction of claim 16, wherein the mask layer further comprises a first major surface facing the optical film and an opposite second major surface, and the integral optical construction further comprises an optical adhesive layer disposed on, and making physical contact with, the second major surface of the mask layer.

21. The integral optical construction of claim 20, wherein each of the openings extends from the first major surface (33) of the mask layer facing the optical film to the second major surface of the mask layer, and wherein the optical adhesive layer fills more than about 50% of a total volume of each of the openings.

22. The integral optical construction of claim 16, wherein the at least one polarization state comprises each of mutually orthogonal first and second polarization states.
